(19) United States
(12) Patent Application Publication
(10) Pub. No.: US 2026/0285252 A1
(43) Pub. Date: Sep. 24, 2026

(54) VEHICLE HAVING A RESTRAINT DEVICE

(71) Applicants: AUTOLIV DEVELOPMENT AB, Vargada (SE); VOLKSWAGEN AG, Wolfsburg (DE)

(72) Inventors: Hakan SUNDMARK, Alingsas (SE); Christer LUNDGREN, Vargarda (SE); Johan FRITZEN, Vargarda (SE); Mattias ENNERDAL, München (DE); Thomas WOHLLEBE, Calberlah (DE)

(21) Appl. No.: 19/480,265

(22) PCT Filed: Apr. 30, 2024
(86) PCT No.: PCT/EP2024/061865

§ 371 Date: Oct. 30, 2025

(30) Foreign Application Priority Data
May 2, 2023 (DE) 10 2023 111 318.6

(51) Int. Cl. B60R 21/233; B60R 21/00

(52) U.S. Cl. CPC B60R 21/233; B60R 2021/0034; B60R 2021/0055; B60R 2021/23308

(57) ABSTRACT

A vehicle having a restraint device for securing a person located on a lying apparatus of the vehicle, wherein the restraint device has at least one upper-body airbag designed in an upper-body portion of the lying apparatus, and a flexible, planar cover element which covers a part of the body surface of the person in a usage position of the cover element. Furthermore, the restraint device has a pelvic airbag arranged in a thigh and/or pelvic portion of the lying apparatus, via which pelvic airbag a lying surface of the lying apparatus is formed projecting outwards in some regions in a release state of the pelvic airbag.

The invention relates to a vehicle having a restraint device for securing a person located on a lying apparatus of the vehicle, wherein the restraint device has at least one upper-body airbag embodied in an upper-body portion of the lying apparatus, and a flexible, planar cover element which covers part of the body surface of the person in a usage position of the cover element.

Traditionally, various active and passive safety systems in motor vehicles ensure the safety of the vehicle's occupants as far as possible. Such safety systems include, for example, seat belts, which may be equipped with active belt tensioners, and airbags which protect an occupant from the front and, if necessary, from the sides. These safety systems have generally proven to be effective, but are usually designed for occupants in a seated position. However, the desire to continuously increase passenger comfort and, in particular, the development of autonomous vehicles require the development of adapted safety systems.

Especially in autonomous vehicles, which at least optionally drive themselves, each passenger can spend the journey in any way they wish—for example, by reading, using visual media, or even resting or sleeping. For increased comfort, it therefore makes sense for passengers to be able to spend a journey in a lying position in which they can, for example, sleep comfortably. While the safety systems described above are effective for upright seating positions, they are not, or only partially, effective for occupants in lying positions. This applies in particular to retractable seat belts, which can be used within a certain angular range relative to their anchorage point on the side of the vehicle. This makes it almost impossible to achieve an effective restraining effect for an occupant in a lying position.

However, proposed solutions for addressing this problem are already known from the prior art.

WO 2006/103 069 A1 discloses a cover, specific to an aircraft, having an integrated restraining function. The cover contains at least one fastening element by which the cover is fastened to a seat and serves to restrain a passenger covered by the cover, in particular one who is sleeping in a lying position, by absorbing a force across a surface in the event of sudden turbulence or flight maneuvers. The cover is connected, in particular, on the shoulder and foot sides, to webbing, the ends of which can each be connected via a lock tongue to a retractor which has a locking function and is arranged on the seat side. The retractor contains, for example, a centrifugal clutch which prevents the belt from unrolling in the event of an unexpected flight maneuver, thereby safely restraining the passenger.

Similarly, U.S. Pat. No. 5,727,814 A discloses a safety cover for restraining an occupant who is asleep and in a lying position on the rear seat bench of a motor vehicle. The safety cover is anchored to the body of the vehicle using measures familiar from classic safety systems, such as webbing with belt tongues.

In addition to such solutions, which essentially comprise only a safety cover, combinations with other safety systems are also known from the prior art.

In this respect, for example, DE 10 2019 115 254 A1 discloses an inflatable safety cover, which likewise serves to protect an occupant of a motor vehicle who is, among other things, in a lying position. The safety cover has an airbag arranged between a first cover layer and a second cover layer connected to the first cover layer. The airbag also has a plurality of independently inflatable chambers which are separated from each other and therefore impermeable to fluids. These chambers cover different regions of the occupant, such as the legs, the pelvic region, and the upper body, and are at different pressures when inflated. It is also possible for the inflatable safety cover having the chambers to be individually produced for the occupant based upon biometric data. These biometric data may include, but are not limited to, the occupant's weight, height, upper body height, and/or leg length. This biometric data may be provided upon purchase of the vehicle, and the safety cover may be individually tailored to the occupant. Other possible ways to record biometric data include using a camera sensor and then analyzing the images to obtain the necessary information. In addition, the safety cover may include a main portion and a head protection portion for protecting the occupant's head. In the non-deployed state, the head protection portion is concealed within an upper portion of the first cover layer and the second cover layer facing the occupant's head, and extends over the occupant's head only when the airbag enters the deployed state. The head protection portion may be formed, on the one hand, by a head protection chamber of the airbag which is inflatable independently of the rest of the airbag, i.e., independently of the main portion. On the other hand, instead of being formed by a chamber of the airbag, the head protection portion may be formed by an independent head protection airbag which is inflatable independently of the main airbag.

However, what the aforementioned solutions have in common is that they achieve increased safety for the occupants in a lying position only at a low level of comfort. For example, it is provided that, during transport in the longitudinal direction, the occupant always be covered to a very large extent, i.e., including the upper body and in particular the arms, by the safety covers, which proves to be quite uncomfortable, even for a sleeping occupant, and especially for an occupant who wants to carry out other activities.

Furthermore, the solutions protect occupants transported in the longitudinal direction from slipping only by the friction between the safety cover and the occupant, which constitutes an insufficient level of safety.

Against this background, the object of the invention is to design a vehicle with a restraint system of the type mentioned at the outset in such a way that the safety of a person lying down in the vehicle is improved, while providing increased comfort.

This object is achieved by a vehicle according to the features of claim 1. The dependent claims relate to particularly expedient further developments of the invention.

According to the invention, a vehicle, preferably a land vehicle, particularly preferably a passenger car, is provided, wherein the vehicle comprises a restraint device for securing a person, in particular in a lying or highly inclined position, on a lying apparatus of the vehicle. The restraint device has at least one upper-body airbag embodied in an upper-body portion of the lying apparatus.

The upper-body portion in which the upper-body airbag is embodied is therefore the portion of the lying apparatus in which the upper body of the person lying down on the lying apparatus is substantially positioned. The portion can be predetermined, for example, on the basis of the dimensions of the 5th-percentile female and/or the 95th-percentile male. It is also conceivable that the lying apparatus be individually adapted to the person using the lying apparatus in such a way that the person's upper body is located in the upper-body portion. Basically, the upper-body portion approximately comprises the head-end third of the lying apparatus, or is situated within this third.

Furthermore, the lying apparatus comprises a flexible, in particular non-rigid and/or tensile-stiff, planar cover element which, in a usage position of the cover element, covers at least, but preferably exclusively, a part of the person's body surface. Furthermore, according to the invention, the restraint device has a pelvic airbag arranged in a thigh and/or pelvic portion of the lying apparatus, via which pelvic airbag a lying surface of the lying apparatus, in a release state of the pelvic airbag, is formed, at least in some regions, in the thigh and/or pelvic portion, so as to be oriented opposite to the interior of the lying apparatus, in particular at least temporarily, i.e., to project outwards. The formation therefore takes place in the direction of the cover element situated in the usage position. In the release state, the pelvic airbag is preferably in a state of maximum deployment.

The thigh and/or pelvic portion in which the pelvic airbag is embodied is accordingly the portion of the lying apparatus in which a transition region between the thigh and pelvis of the person lying down on the lying apparatus is substantially positioned. This portion can in turn be predetermined on the basis of the dimensions of the 5th-percentile female and/or the 95th-percentile male. It is also conceivable that the lying apparatus be individually adapted to the person using the lying apparatus in such a way that the transition region between the person's thigh and pelvis is located in the thigh and/or pelvic portion. Basically, the thigh and/or pelvic portion covers approximately the central third of the lying apparatus, or is situated in this third.

Furthermore, the pelvic airbag is preferably positioned in the center of the lying apparatus and/or either is arranged below the lying surface, which is, for example, covered with a fabric, or forms part of the lying surface.

The pelvic airbag advantageously serves, particularly in an early phase of an accident, to pivot the person's thighs upwards in order to cause the knees to buckle when the person, particularly in the case of a frontal impact, is displaced relative to the lying apparatus in the direction of the impact point—in this case, often in the direction of travel, or forwards. On the one hand, this reduces the load on the person's legs and especially their knees, which minimizes the risk of injury. Furthermore, the restraining effect of the cover element is increased due to the angular position of the person's legs. In a later phase of an accident, the pelvic airbag also forms a type of wedge or ramp under the pelvis of the person being displaced on the lying apparatus during the accident, whereby the person is moved into the cover element. The pelvic airbag acting as a ramp, the increased form-fit between the person and the cover element resulting therefrom and due to the bent legs, and/or the force action of the cover element upon the person further increase the restraint of the person by means of the cover element during this accident phase.

In this way, the safety of the person lying down on the lying apparatus of the vehicle is significantly improved, while also providing increased comfort.

In a particularly advantageous further development of the invention, at least one upper-body airbag is embodied in each of the two longitudinal side regions, corresponding to the upper-body portion, of the lying apparatus. The upper-body airbags are located in the same longitudinal position in the upper-body portion of the lying apparatus. The design of the upper-body airbags offers the fundamental advantage that the upper body and, for example, also the person's arms can remain uncovered by the cover element, and that the latter extends, for example, only from the beginning of the lower legs to the person's pelvis. This increases the comfort of the person on the lying apparatus, since their mobility is largely maintained. In addition, the arrangement in the side region of the lying apparatus, in particular compared to an arrangement on or in a vehicle structure facing the lying surface of the lying apparatus, e.g., located above the lying apparatus, has the advantage that the person can be provided with significantly greater freedom of movement, and the time it takes for the upper-body airbags to fully deploy can be shortened. However, in a design on or in a vehicle structure facing the lying surface of the lying apparatus, a small spacing from the vehicle structure should be selected in order to ensure a small volume and thus a short deployment time; otherwise, a longer deployment time would have to be accepted, which, however, reduces the safety of the person.

It is furthermore advantageous if the upper-body airbags embodied in the two longitudinal side regions of the lying apparatus, in a release state, are formed, at least temporarily, to extend from the side regions, at least in portions transversely across the lying surface of the upper-body portion, wherein the upper-body airbags bear against one another at least in portions. In the release state, the upper-body airbags are preferably in a state of maximum deployment. This configuration efficiently helps ensure that, in the event of an accident, the person is pressed, normal to the lying surface of the lying apparatus, in particular vertically, over a large area towards the lying apparatus, or is held there. In the longitudinal direction of the lying apparatus, a further objective may be to clamp the person's upper body using the—in particular, two-upper-body airbags.

Furthermore, it is advantageous if the upper-body airbags have at least one main chamber and at least one secondary chamber, wherein the main chamber and the secondary chamber are connected in a fluid-permeable manner via at least one overflow opening. In a further development based in particular upon this, a particular secondary chamber is arranged on a main chamber such that, in the release state of the upper-body airbag, it is formed facing the lying surface. The secondary chamber preferably has a smaller volume than the main chamber and extends, in the release state, substantially over the entire width of the main chamber, oriented in the longitudinal direction of the lying apparatus. Thus, the side chamber has a rather elongated configuration. The design of the upper-body airbags with the two chambers, i.e., a main chamber and a secondary chamber, achieves a substantially homogeneous envelopment of the person's upper body, whereby high normal forces act upon the upper body. The restraint in the upper body region is substantially achieved by way of frictional forces, i.e., the friction between the upper-body airbags and the person, as well as between the person and the lying apparatus.

Furthermore, the upper-body airbags may also be designed such that, in the release state, in particular via the main and/or secondary chamber, they also restrain the head. However, it would also be conceivable for a further chamber, e.g., a head chamber, to be arranged on the main and/or secondary chamber.

In a further advantageous embodiment of the invention, at least one of the upper-body airbags, in the release state, is supported, in particular transversely to the longitudinal direction of the lying apparatus, at least in portions on at least one vehicle structure which forms an abutment for the upper-body airbag and is located in the interior of the vehicle and/or facing the interior of the vehicle. Because the upper-body airbags are supported, the forces exerted on the person by the upper-body airbags, in particular normal forces, can advantageously be increased, so that the restraint forces or the restraining effect are also increased. In this case, the vehicle structures forming an abutment on a side, facing the vehicle exterior, of the upper-body airbags may, for example, be the doors and/or pillars, such as the A and/or B pillar, of the vehicle, designed, for example, as a passenger car, or the respective trim panels. On the inner side of the upper-body airbags, however, the vehicle structures comprise, for example, a center console or possible partition walls to increase the privacy of the people in the vehicle.

In a further advantageous refinement of the invention, the cover element is connected to the lying apparatus at least in one longitudinal side region, but preferably in both longitudinal side regions, of the lying apparatus at at least two attachment points and, in this case, via at least one connecting element at each attachment point. Developing this refinement further, it is provided that at least one connecting element of the two attachment points located in or adjacent to the thigh and/or pelvic portion be designed at least in part as a force limiter. The design of connecting elements as force limiters has the advantage of limiting, in the event of an accident, the force acting upon the person via the cover element, in particular in the longitudinal direction of the lying apparatus, when the person is displaced towards the point of impact, as well as the force acting through the cover element normal to the longitudinal direction of the lying apparatus, in particular upon the person's knees. In this case, a connecting element embodied at a first attachment point in each side region may, for example, in addition to the design as a force limiter, also be configured as a tensioner for the cover element, wherein a connecting element embodied at a second attachment point in each side region is configured exclusively as a force limiter. In a preferred embodiment in which three attachment points are provided in each side region, a connecting element of the third attachment point would be configured merely as a fixed connector. In addition to these connecting elements, further attachment elements designed as coupling elements may be provided at each attachment point in at least one longitudinal side region, but preferably in both longitudinal side regions, via which the cover element can be fastened to and/or detached from the lying apparatus, in particular by the person. It is conceivable that the coupling elements be configured as a belt buckle and/or belt tongue.

It is likewise advantageous if a zone having variable stiffness and/or hardness is formed in the upper-body portion within the lying apparatus. On the one hand, in particular in the event of an accident, possible immersion of the person's upper body into the lying apparatus can thus be minimized or even avoided, and, on the other, an additional force action can be generated from the rear, acting in particular upon the person's upper body. This advantageously leads to improved contact of the upper-body airbags and/or the cover element with the person.

It is also considered advantageous if the zone of variable stiffness and/or hardness is formed by a stiffening device and/or a material having variable stiffness and/or hardness. If the stiffening device is designed as a stiffening airbag, this results in a structurally advantageous and simple configuration of the stiffening device, which is also in line with the arrangement of further airbags, such as the upper-body airbags and the pelvic airbag, thus realizing a holistic concept. This allows, for example, for uniform control and a simplified supply chain.

In a further, particularly advantageous embodiment of the invention, the lying apparatus is movably arranged on a base frame, in particular a chassis and/or a body, of the vehicle, in particular a passenger car. For this purpose, the lying apparatus may be mounted in at least one guide, e.g., a linear guide such as a guide rail, which is arranged on the base frame. In this way, movability can be achieved in a structurally advantageous and simple manner. It is likewise advantageous, in the above sense and in general, if the lying apparatus and the base frame are coupled or connected to one another via at least one energy absorption element—for example, a damping element and/or a deformation element. In this case, the combination of a movable lying apparatus and additional coupling via the energy absorption element advantageously ensures that the vehicle accelerations or decelerations which occur, in particular, in the event of an accident do not fully affect the person lying on the lying apparatus. To this end, the lying apparatus, together with the person, moves, particularly in the case of a frontal impact, due to inertia, preferably within the guide towards the point of impact-here, often in the direction of travel, i.e., forwards. The energy absorption element dissipates or converts energy and reduces the impulse and/or force acting upon the lying apparatus and thus upon the person.

Furthermore, it is also advantageous if a footrest, in particular one designed separately from the lying apparatus and displaceable relative to the lying apparatus, is arranged at the end of the lying apparatus. For this purpose, the footrest may be mounted in at least one guide, e.g., a linear guide such as a guide rail, which is arranged on the lying apparatus. By providing the footrest, the person's safety against slipping off the lying apparatus can be advantageously increased. Developing this refinement further, and also in general, it is moreover advantageous if the lying apparatus and footrest are coupled or connected to one another via at least one energy absorption element—for example, a damping element and/or deformation element. In this connection, the combination of the displaceability of the footrest and the coupling of the footrest and the lying apparatus via the energy absorption element offers particular advantages. The person lying on the lying apparatus is, in particular in the case of a frontal impact, due to inertia, displaced relative to the lying apparatus towards the point of impact—here, often in the direction of travel, i.e., forwards. During the displacement, the person exerts a force on the footrest, which is then displaced, in particular within the guide thereof. The energy absorption element dissipates or converts energy during displacement, thereby minimizing the risk of injury to the person. In addition, it can be provided that the footrest have a cushion on a side of the footrest facing the lying apparatus and/or the person in order to avoid a sudden increase in force when the person's feet first come into contact with the footrest.

In principle, it is also conceivable in the context of the invention, for different persons lying on the lying apparatus, that the upper-body airbags, the pelvic airbag, the zone, here in particular the stiffening device designed as a stiffening airbag, e.g., with regard to pressure and/or volume, the energy absorption elements and/or the connecting elements, e.g., the force limiter and/or tensioner of the restraint cover, be, or be able to be, parameterized in a person-specific manner.

The invention allows for numerous embodiments. For further clarification of the basic principles of the embodiments, some of them are shown in the drawing and described below. In the drawings,

FIG. 1 shows a restraint device with non-released airbags;

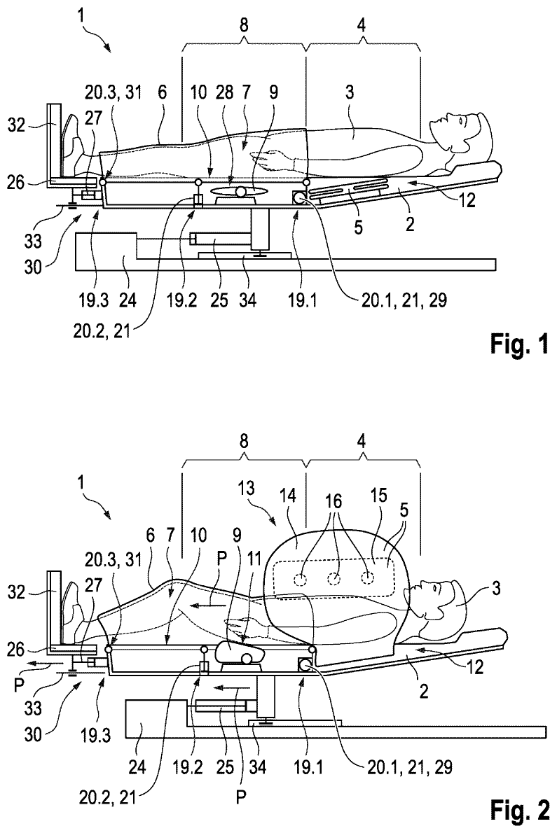

FIG. 2 shows a restraint device with released airbags;

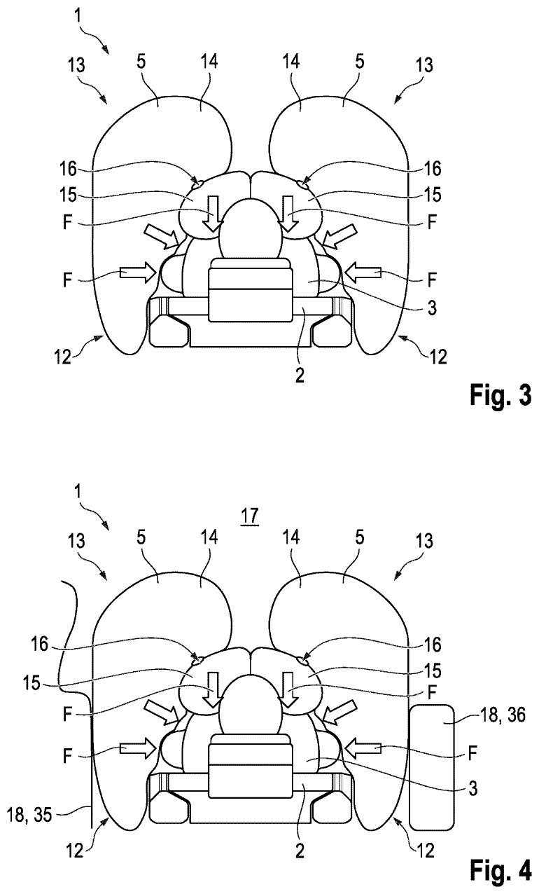

FIG. 3 is a top view of a restraint device with upper-body airbags in the release state;

FIG. 4 is a top view of a restraint device with upper-body airbags, supported on vehicle structures, in the release state;

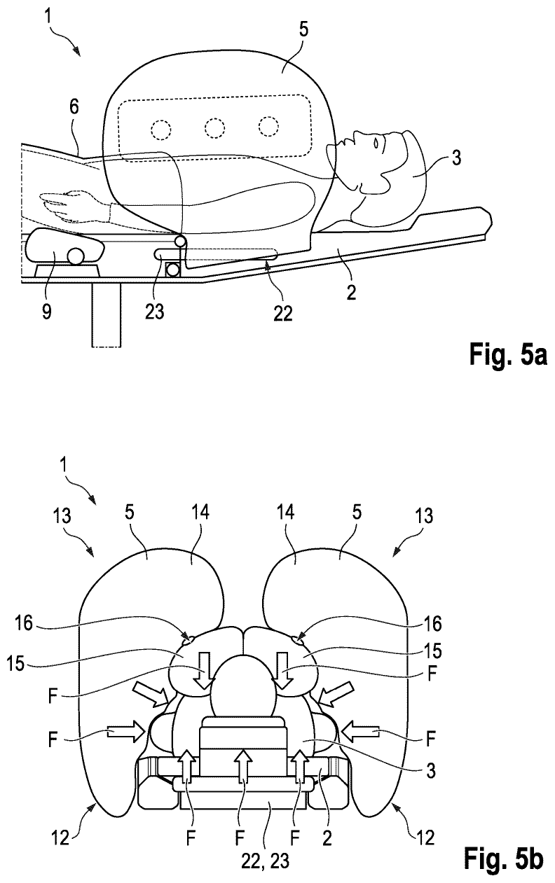

FIGS. 5a, 5b show a restraint device with an additional stiffening apparatus.

FIGS. 1 and 2 show a further development of the restraint device 1 according to the invention for arrangement in a vehicle not shown in detail. In this case, the restraint device 1 serves to secure the person 3 located on the lying apparatus 2. To this end, the restraint device 1 has two upper-body airbags 5 embodied in the upper-body portion 4 of the lying apparatus 2, and the pelvic airbag 9 arranged in a thigh and/or pelvic portion 8 of the lying apparatus 2. In particular, one of the upper-body airbags 5 is arranged in each case in one of the two longitudinal side regions 12 of the lying apparatus 2, and the pelvic airbag 9 is arranged centrally in the lying apparatus 2.

Furthermore, the restraint device 1 has the flexible, non-rigid, and planar cover element 6, which is designed as a restraint cover. In the usage position 7 of the cover element 6 shown in FIGS. 1 and 2, the cover element 6 covers only part of the body surface of the person 3 in order to allow the person 3 to lie as comfortably as possible on the lying apparatus 2.

In the usage position 7, the cover element 6 is also connected, in both longitudinal side regions 12 of the lying apparatus 2, to the lying apparatus 2 at three attachment points 19.1, 19.2, 19.3. In particular, the connection of the cover element 6 to the lying apparatus 2 is effected via a single connecting element 20.1, 20.2, 20.3 at each attachment point 19.1, 19.2, 19.3. In this case, the two connecting elements 20.1, 20.2, which are arranged in the attachment points 19.1, 19.2 located in the thigh and/or pelvic portion 8 or adjacent to the thigh and/or pelvic portion 8 and thereby substantially enclose the pelvic region of the person 2, are designed at least in part as a force limiter 21. Specifically, the first connecting element 20.1 arranged in the first attachment point 19.1 located between the upper-body airbag 5 and the pelvic airbag 9 is designed as a force limiter 21 and as a tensioner 29. The connecting element 20.2 arranged in the second attachment point 19.2 between the pelvic airbag 9 and the foot-side end 30 of the lying apparatus 2, however, is configured only as a force limiter 21. In addition to the two connecting elements 20.1, 20.2, the third connecting element 20.3 is also arranged in the attachment point 19.3 located at the foot-side end 30 of the lying apparatus 2, which third connecting element is configured as a fixed connector 31, in particular a closed hook or rivet.

The restraint device 1 further comprises the footrest 26 arranged at the end, here at the foot-side end 30, of the lying apparatus 2, which footrest is mounted to be displaceable relative to the lying apparatus 2 via the guide 33. The lying apparatus 2 and the footrest 26 are also coupled to one another via the energy absorption element 27—in this case, a damping element. Furthermore, the footrest 26 has the cushion 32 on the side of the footrest 26 facing the foot-side end 30 and/or the person 3.

The lying apparatus 2 itself is movably arranged on the base frame 24 of the vehicle (not shown in detail) via the guide 34, wherein the lying apparatus 2 and the base frame 24 are coupled to one another via the energy absorption element 25, which here is likewise a damping element.

In the accident scenario shown in FIG. 2, the movable arrangement of the lying apparatus 2 on the base frame 24 and the embodiment of the energy absorption element 25 between the lying apparatus 2 and the base frame 24 mean that the vehicle accelerations or decelerations which occur do not fully act upon the person 3 located on the lying apparatus 2. To this end, the lying apparatus 2, together with the person 3, moves, due to inertia, within the guide 34 relative to the base frame 24 in the event of a frontal impact in, for example, the direction of travel. The movement is indicated in FIG. 2 by arrows P. During the movement, energy is dissipated or converted via the energy absorption element 25, and the impulse and/or the force acting upon the lying apparatus 2 and thus upon the person 3 is reduced. Furthermore, due to inertia, the person 3 himself is also displaced relative to the lying apparatus 2. This displacement is also indicated in FIG. 2 by an arrow P. During the displacement, the person 3 exerts a force upon the footrest 26, which in turn is displaced within the guide 33 thereof. The energy absorption element 27 dissipates or converts energy during displacement, thereby minimizing the risk of injury to the person 3. The cushion 32 also prevents a sudden increase in force when the feet of the person 3 first come into contact with the footrest 26.

In the event of an accident, the upper-body airbags 5 and the pelvic airbag 9 are released at the same time as or even before the onset of the movement or displacement of the lying apparatus 2 and person 3. Simultaneously, the cover element 6 is tensioned via the first connecting element 20.1, which, as already explained, functions not only as a force limiter 21, but also as a tensioner 29. Because of this tensioning and a large-area distribution of force over the cover element 6, the person's pelvis in particular is pressed against the lying surface 10 of the lying apparatus 2. By way of the pelvic airbag 9, the lying surface 10 of the lying apparatus 2 is, in the release state 11 of the pelvic airbag 9 shown in FIG. 2, as compared with the rest state 28 of the pelvic airbag 9 shown in FIG. 1, formed to project outwards in some regions and/or be raised.

The pelvic airbag 9 serves, in particular in an early phase of an accident, to pivot the thighs of the person 3 upwards in order to cause the knees to buckle when the person 3 is displaced relative to the lying apparatus 2 in the direction of the footrest 26. On the one hand, this reduces the load on the legs and especially the knees of the person 3, and on the other, the restraining effect of the cover element 6 is increased due to the angular position of the legs of the person 3. In this case, force limitation is effected by the second connecting element 20.2, designed as a force limiter 21, which in particular minimizes the risk of injury to the person 3. Particularly in a later phase of an accident, the pelvic airbag 9 also forms a type of wedge or ramp under the pelvis of the person being displaced on the lying apparatus 2, whereby the person 3 is moved into the cover element 6. The resulting increased form-fit between the person 3 and the cover element 6, brought about by the pelvic airbag 9 acting as a ramp and additionally by the bent legs, and/or the force action of the cover element 6 upon the person 3 increase the restraint of the person 3 by means of the cover element 6 significantly during this accident phase. In addition, a force limitation is effected by the first connecting element 20.1, likewise designed as a force limiter 21, which further minimizes the risk of injury to the person 3.

The upper-body airbags 5, which are likewise released and are located in the two longitudinal side regions 12 of the lying apparatus 2, in the release state 13 thereof, which is shown again in a top view in FIG. 2 and in FIGS. 3 and 4, extend, starting from the side regions 12, in portions transversely across the lying surface 10 of the upper-body portion 4. The upper-body airbags 5 each have the main chamber 14 and the secondary chamber 15, wherein the main chamber 14 and the secondary chamber 15 are connected in a fluid-permeable manner via a plurality of—here, in particular, three-overflow openings 16. A particular secondary chamber 15 is also arranged on the main chamber 14 such that, in the release state 13 of the upper-body airbag 5, it is formed to face the lying surface 10. The secondary chambers 15 have a smaller volume than the main chambers 14 and extend almost over the entire width of the main chambers 14, oriented in the longitudinal direction of the lying apparatus 2, and therefore have a rather elongated design.

The upper-body airbags 5 are furthermore designed, via the secondary chambers 15, such that they also provide restraint of the head of the person 3, as shown in particular in FIG. 2.

FIGS. 3 and 4 further illustrate, in detail, that the design of the upper-body airbags 5 with the main chamber 14 and the secondary chamber 15 achieves a homogeneous envelopment of the upper body of the person 3, wherein the upper-body airbags 5 and the secondary chambers 15 bear against one another at least in portions and thus exert high normal forces F upon the upper body of the person 3.

The normal forces F acting upon the person 3 can furthermore be increased, in that, as shown in FIG. 4, the upper-body airbags 5, in release state 13 thereof, are supported in portions on at least one vehicle structure 18 which forms an abutment for the upper-body airbag 5 and is located in the interior 17 of the vehicle and/or facing the interior 17 of the vehicle. In this embodiment, the vehicle structure 18 forming the abutment on a side, facing the vehicle exterior, of the upper-body airbags 5 is the door 35. On the inner side of the upper-body airbags 5, the vehicle structure 18 comprises the center console 36.

FIGS. 5a and 5b also show a further refinement of the restraint device 1, which, in addition to the cover element 6, the upper-body airbags 5, and the pelvic airbag 9, also has the zone 22 which has variable stiffness and/or hardness and is formed in the upper-body portion 4 within the lying apparatus 2. The zone 22 is formed by the stiffening device 23, which in turn is a stiffening airbag. As a result, immersion of the upper body of the person 3 into the lying apparatus 2 can be minimized, and, moreover, an additional normal force F can be generated on the rear side of the upper body of the person 3. This leads to improved contact of the upper-body airbags 5 and of the cover element 6 with the person 3.

List of reference signs

| | |
|---|---|
| 1 | Restraint device |
| 2 | Lying apparatus |
| 3 | Person |
| 4 | Upper-body portion |
| 5 | Upper-body airbag |
| 6 | Cover element |
| 7 | Usage position |
| 8 | Thigh and/or pelvic portion |
| 9 | Pelvic airbag |
| 10 | Lying surface |
| 11 | Release state |
| 12 | Side region |
| 13 | Release state |
| 14 | Main chamber |
| 15 | Secondary chamber |
| 16 | Overflow opening |
| 17 | Interior |
| 18 | Vehicle structure |
| 19.1 | Attachment point |
| 19.2 | Attachment point |
| 19.3 | Attachment point |
| 20.1 | Connecting element |
| 20.2 | Connecting element |
| 20.3 | Connecting element |
| 21 | Force limiter |
| 22 | Zone |
| 23 | Stiffening device |
| 24 | Base frame |
| 25 | Energy absorption element |
| 26 | Footrest |
| 27 | Energy absorption element |
| 28 | Rest state |
| 29 | Tensioner |
| 30 | Foot-side end |
| 31 | Fixed connector |
| 32 | Cushion |
| 33 | Guide |
| 34 | Guide |
| 35 | Door |
| 36 | Center console |
| F | Normal force |
| P | Arrow |

1. A vehicle having a restraint device for securing a person located on a lying apparatus of the vehicle, wherein the restraint device has at least one upper-body airbag embodied in an upper-body portion of the lying apparatus, and a flexible, planar cover element which covers part of the body surface of the person in a usage position of the cover element, wherein the restraint device has a pelvic airbag arranged in a thigh and/or pelvic portion of the lying apparatus, via which pelvic airbag a lying surface of the lying apparatus is formed to project outwards in some regions in a release state of the pelvic airbag.

2. The vehicle according to claim 1, wherein at least one upper-body airbag is embodied in each of the two longitudinal side regions of the lying apparatus.

3. The restraint device according to claim 1, wherein upper-body airbags embodied in the two longitudinal side regions of the lying apparatus, in the release state thereof, extend, starting from the side regions, at least in portions transversely across the lying surface of the upper-body portion, wherein the upper-body airbags bear against one another at least in portions.

4. The vehicle according to claim 1, wherein the upper-body airbags have at least one main chamber and at least one secondary chamber, wherein the main chamber and the secondary chamber are connected in a fluid-permeable manner via at least one overflow opening, and a particular secondary chamber is arranged on a main chamber in such a way that, in the release state of the upper-body airbag, it is formed facing the lying surface.

5. The vehicle according to claim 1, wherein at least one of the upper-body airbags, in the release state, is supported at least in portions on at least one vehicle structure which forms an abutment for the upper-body airbag and is located in the interior of the vehicle and/or facing the interior of the vehicle.

6. The vehicle according to claim 1, wherein the cover element—is connected, in at least one longitudinal side region of the lying apparatus, to the lying apparatus at at least two attachment points via at least one connecting element at each attachment point, wherein a connecting element of the attachment points located in the thigh and/or pelvic portion or adjacent to the thigh and/or pelvic portion is designed at least in part as a force limiter.

7. The vehicle according to claim 1, wherein a zone having variable stiffness and/or hardness is formed in the upper-body portion within the lying apparatus.

8. The vehicle according to claim 1, wherein the zone of variable stiffness and/or hardness is formed by a stiffening device and/or by a material having variable stiffness and/or hardness.

9. The vehicle according to claim 1, wherein the lying apparatus is movably arranged on a base frame of the vehicle, wherein the lying apparatus and the base frame are additionally coupled to one another via at least one energy absorption element.

10. The vehicle according to claim 1, wherein a footrest which is displaceable relative to the lying apparatus is arranged at the end of the lying apparatus, wherein the lying apparatus and the footrest are additionally coupled to one another via at least one energy absorption element.
